(19) United States
(12) Patent Application Publication
(10) Pub. No.: US 2011/0170743 A1
(43) Pub. Date: Jul. 14, 2011

(54) METHOD FOR DETECTING OBJECT MOVEMENT AND DETECTION SYSTEM

(75) Inventor: En Feng HSU, Hsin-Chu (TW)

(73) Assignee: PIXART IMAGING INC., Hsin-Chu County (TW)

(21) Appl. No.: 12/984,897

(22) Filed: Jan. 5, 2011

(30) Foreign Application Priority Data
Jan. 11, 2010 (TW) 099100507
May 11, 2010 (TW) 099115205

(51) Int. Cl. G06K 9/00

(52) U.S. Cl. 382/103

(57) ABSTRACT

This invention relates to a method for detecting object movement by dynamically updating a reference image data. By dynamically updating the reference image data, the impact of the ambient light change can be reduced and the detection error of object movement caused by using fixed reference image data under varying ambient light can also be avoided. The present invention further provides a detection system.

### CROSS REFERENCE TO RELATED APPLICATION

This application claims the priority benefit of Taiwan Patent Application Ser. No. 099100507, filed on Jan. 11, 2010 and Taiwan Patent Application Ser. No. 099115205, filed on May 11, 2010, the full disclosure of which is incorporated herein by reference.

### BACKGROUND

1. Field of the Invention

This invention generally relates to a method for detecting object movement and a detection system and, more particularly, to a method for detecting object movement by dynamically updating a reference image data and a detection system using the same.

2. Description of the Related Art

A current technique for detecting a relative movement between two objects with an image sensor is to install the image sensor on one of the two objects and to determine the relative movement by identifying whether corresponding information of the other object is included in the acquired images. For example, there is an image processing method that directly identifies whether the other object is contained in the acquired images; or an optical processing method that identifies whether the acquired images contain reflected light or illuminated light from the other object or the blocking shadow of the other object.

Taking the aforementioned optical processing method as an example, as environmental stray light sources may also be sensed by the image sensor during detecting the object movement, the detection of the object movement will be affected when the shadow or light of these stray light sources are sensed by the image sensor, thereby reducing the detection stability.

For example, one conventional optical processing method may directly acquire a plurality of image frames with an image sensor and then analyze the variation of the object image in every image frame so as to calculate the object movement, but this kind of technique has a lower tolerance to environmental stray light sources. In addition, there is another optical processing method in which a specific light source is provided to emit light to a surface of the object to be detected. And the light source is turned on and turned off alternatively during acquiring images, and the acquired image corresponding to the light source being turned on is subtracted by the acquired image corresponding to the light source being turned off so as to eliminate the impact of ambient light. Although this kind of technique has a higher tolerance to stray light sources, the accuracy of movement detection to a fast moving object is relatively lower.

Therefore, a method that can improve the detection stability of object movement and can detect a fast moving object is desired by this field of the art.

### SUMMARY

The present invention provides a method for detecting object movement by dynamically updating a reference image data. By dynamically updating the reference image data, the impact of the ambient light change can be reduced and the detection error of object movement caused by using fixed reference image data under varying ambient light can also be avoided.

The present invention further provides a method for detecting object movement by dynamically updating a reference image data. When a variation between two image data is larger than a threshold value, the method is applicable for detecting slow moving object by dynamically updating the reference image data and the impact of the ambient light change can be reduced. The method is able to avoid the detection error of object movement caused by using fixed reference image data under varying ambient light.

The present invention provides a method for detecting object movement including the steps of: successively acquiring image data with an image sensor; updating the latest acquired image data as a current image data; updating the Nth image data acquired earlier than the current image data as a reference image data; and calculating an object movement data according to a difference between the current image data and the reference image data.

In an aspect, N is equal to 1 or 2 or may be determined according to the object movement data.

The present invention further provides a method for detecting object movement including the steps of: acquiring a first image data as a reference image data; acquiring a second image data as a current image data; calculating a difference between the current image data and the reference image data to be served as an object movement data; and determining whether to update the reference image data according to the difference and a threshold value.

In an aspect, the method for detecting object movement further includes the steps of: reserving the reference image data when the difference is smaller than the threshold value; and updating the second image data as an updated reference image data when the difference is larger than the threshold value.

In an aspect, the method for detecting object movement further includes the steps of: acquiring a third image data and updating the third image data as an updated current image data; calculating an updated object movement data according to a difference between the updated current image data and the reference image data when the difference is smaller than the threshold value; and calculating an updated object movement data according to a difference between the updated current image data and the updated reference image data when the difference is larger than the threshold value.

The present invention further provides a detection system including an image sensor and a processing unit. The image sensor is configured to generate image data. The processing unit is configured to receive the image data, to dynamically update a reference image data, to calculate an objet movement data according to a difference between the reference image data and a current image data, which is a latest image data generated by the image sensor, and to compare the object movement data with a threshold value so as to determine whether to update the reference image data.

In an aspect, the threshold value may be a two dimensional movement of the object to be detected, a one dimensional movement of the object to be detected or an average gray level variation of the image data.

### BRIEF DESCRIPTION OF THE DRAWINGS

Other objects, advantages, and novel features of the present invention will become more apparent from the following detailed description when taken in conjunction with the accompanying drawings.

FIG. 1 shows a block schematic diagram of the detection system according to the embodiment of the present invention.

FIG. 2 shows a schematic diagram of the method for detecting object movement according to the first embodiment of the present invention.

FIG. 3 shows a schematic diagram of the method for detecting object movement according to the second embodiment of the present invention.

FIG. 4 shows a schematic diagram of the method for detecting object movement according to the third embodiment of the present invention.

### DETAILED DESCRIPTION OF THE EMBODIMENT

Details of the present invention will be explained with embodiments that are relative to a method for detecting object movement and a detection system. The object movement is detected by performing a step of dynamically updating a reference image data and by subtracting an updated reference image data from a currently acquired image data. However, embodiments of the present invention are not to limit the present invention to any particular environment, application or implementation as described. Therefore, embodiments are only for illustrations rather than limitations of the present invention. It should be noted that, in the embodiments and drawings below, components that do not directly relate to the present invention are omitted and the size relationship between components is shown with a slight exaggeration for easier understanding.

The present invention is relative to a method for detecting object movement and, more particularly, to a method for detecting object movement by performing a step of dynamically updating a reference image data and a detection system using the same.

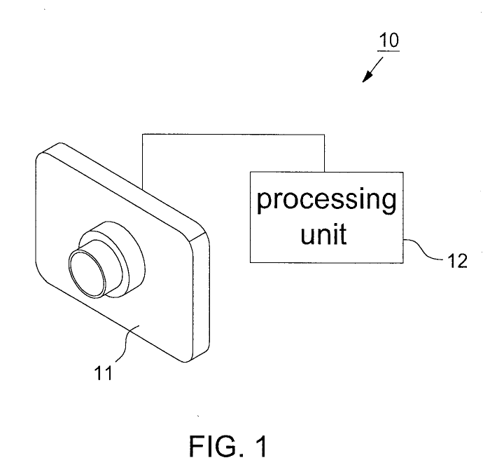

Please refer to FIG. 1, it shows a block schematic diagram of the detection system according to an embodiment of the present invention. The detection system 10 includes an image sensor 11 and a processing unit 12. The image sensor 11 may be, for example, a camera for detecting an object movement thereby generating an image data. The processing unit 12 receives the image data generated by the image sensor 12, dynamically updates a reference image data, and calculates an object movement data according to a difference between the reference image data and a current image data latest acquired by the image sensor 11.

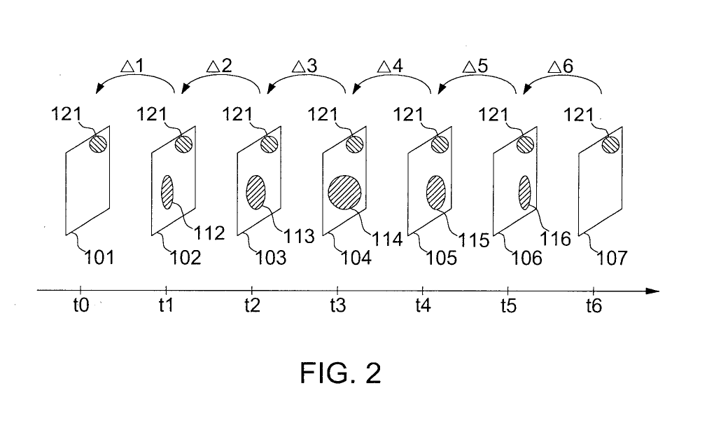

FIG. 2 shows a schematic diagram of the method for detecting object movement according to the first embodiment of the present invention, and this method may be implemented by using the detection system 10 of FIG. 1. When an object movement is detected by the image sensor 11, the image relative to the object movement, e.g. the image of the object illuminating light or reflecting light, will be included in image frames acquired by the image sensor 11 and contained in an image data generated by the image sensor 11. Details of this method will be illustrated hereinafter using the image data acquired by the image sensor 11.

Please refer to FIG. 2, at time t₀, the image sensor 11 acquires an image and generates a first image data 101. The first image data 101 is served as a reference image data which includes a stray light image data 121 herein. At time t₁, the image sensor 11 acquires an image and generates a second image data 102 which includes the stray light image data 121 and a movement image data 112 generated by object movement. At this moment, the processing unit 12 subtracts the reference image data (i.e. the first image data 101) from the second image data 102. It is known from FIG. 2, the movement image data 112 is left after subtraction and thus an object movement data Δ1 is obtained. More specifically, both the second image data 102 and the first image data 101 include identical stray light image data 121, but the movement image data 112 is generated during object movement at time t₁ which is not included in the first image data 101. Therefore, an object movement image data Δ1 can be obtained by subtracting the first image data 101 from the second image data 102. Next, the processing unit 12 updates the second image data 102 as an updated reference image data to replace the previous image data (i.e. the first image data 101). Then at time t₂, the image sensor 11 acquires a third image data 103 which also includes the stray light image data 121 and a movement image data 113 generated by continuous moving of the object. At this movement, the processing unit 12 subtracts the updated reference image data (i.e. the second image data 102) from the third image data 103. It is known from FIG. 2, an updated movement image data is left after subtraction (i.e. subtracting the movement image data 113 by the movement image data 112) and thus an object movement data Δ2 is obtained.

Next, using a procedure similar to that aforementioned, the third image data 103 is updated as an updated reference image data to replace the previous reference image data, i.e. the second image data 102. Then at time t₃, the image sensor 11 acquires a fourth image data 104 which also includes the stray light image data 121 and a movement image data 114 generated by continuous moving of the object. Then an object movement data Δ3 can be obtained by subtracting the updated reference image data (i.e. the third image data 103) from the fourth image data 104. Similarly, a fifth image data 105, a sixth image data 106 and a seventh image data 107 can be respectively obtained at times t₄, t₅ and t₆. By updating an immediately previous image data as the reference image data and subtracting the image data by corresponding reference image data, object movement data Δ4, Δ5 and Δ6 can be obtained. By repeating the above procedure, the object movement data can be continuously updated.

An advantage of the first embodiment is that, relative to the method using a fixed reference image data as a comparison basis, the first embodiment of the present invention is able to reduce the impact of varying ambient light sources on the accuracy of identifying object movement by updating an immediately previous image data as a reference image data. It is able to assure the frame rate of the system high enough to operate normally by directly using an immediately previous image data as the reference image data.

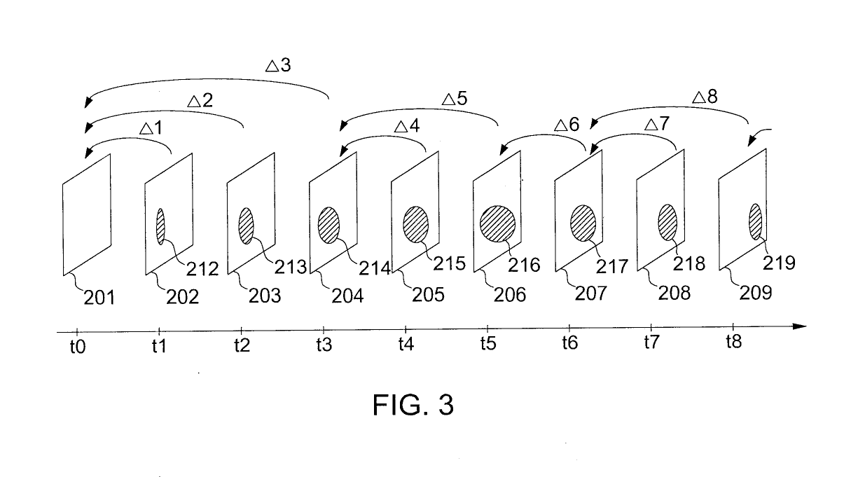

FIG. 3 shows a schematic diagram of the method for detecting object movement according to the second embodiment of the present invention, and this method may also be implemented by using the detection system 10 as the first embodiment. The main difference between the second embodiment and the first embodiment is that, in addition to identifying a difference between two successive image data, the second embodiment also identifies a difference between a latest image data and a current reference image data, wherein the difference between two successive image data is used to detect object movement while the difference between the latest image data and the current reference image data is used to be compared with a threshold value. The reference image data is updated only when the difference between the latest image data and the current reference image data is larger than the threshold value. The threshold value may be a two dimensional movement or a one dimensional movement (e.g. a transverse movement and/or a longitudinal movement) of the object to be detected or an average gray level variation of the image data. In addition, the stray light image data will not be shown in the second embodiment since it is already known from the first embodiment that the stray light image data can be eliminated in the subtraction of two image data. Details of the second embodiment will be illustrated hereinafter.

Please refer to FIG. 3, at time t₀, the image sensor 11 acquires an image and generates a first image data 201. The first image data 201 is served as an initial reference image data. At time t₁, the image sensor 11 acquires an image and generates a second image data 202 which includes a movement image data 212 generated by object movement. An object movement data Δ1 can be obtained by subtracting the first image data 201 from the second image data 202. At this moment, the detection system 10 compares Δ1 with a threshold value. If Δ1 is larger than the threshold value, the detection system 10 updates the second image data 202 as an updated reference image data; otherwise, the detection system 10 reserves the first image data 201 as the reference image data. In the present embodiment, Δ1 is assumed to be smaller than the threshold value, and thus the first image data 201 is still used as the reference image data. At time t₂, the image senor 11 acquires an image and generates a third image data 203 which includes a movement image data 213 generated by object movement. An object movement data Δ2 can be obtained by subtracting the reference image data (i.e. the first image data 201) from the third image data 203. At this moment, the detection system 10 compares Δ2 and the threshold value. In this embodiment, it is assumed that Δ2 is still smaller than the threshold value, and thus the detection system 10 continuously reserves the first image data 201 as the reference image data. At time t₃, the image sensor 11 acquires an image and generates a fourth image data 204 which includes a movement image data 214 generated by object movement. An object movement data Δ3 can be obtained by subtracting the reference image data (i.e. the first image data 201) from the fourth image data 204. At this moment, the detection system 10 compares Δ3 and the threshold value. In this embodiment, Δ3 is assumed to be larger than the threshold value, and thus the detection system 10 updates the fourth image data 204 as an updated reference image data.

At time t₄, the image sensor 11 acquires an image and generates a fifth image data 205 which includes a movement image data 215 generated by object movement. An object movement data Δ4 can be obtained by subtracting the reference image data (i.e. the fourth image data 204) from the fifth image data 205. At this moment, the detection system 10 compares Δ4 and the threshold value. In this embodiment, Δ4 is assumed to be smaller than the threshold value, and thus the detection system 10 continuously reserves the fourth image data 204 as the reference image data. Similarly, at time t₅, the processing unit 12 subtracts the reference image data (i.e. the fourth image data 204) from the sixth image data 206 to obtain an object movement data Δ5. In this embodiment, Δ5 is assumed to be larger than the threshold value, and thus the detection system 10 updates the sixth image data 206 as an updated reference image data. Similarly, in the second embodiment, a seventh image data 207 and a ninth image data 209 are respectively updated as an updated reference image data. An object movement data Δ7 obtained by subtracting the reference image data (i.e. the seventh image data 207) from the eighth image data 208 is assumed to be smaller than the threshold value.

An advantage of the second embodiment is that, relative to the method using a fixed reference image data as a comparison basis, the second embodiment of the present invention updates a currently acquired image data as a new reference image data when a difference of the image data (e.g. a two dimensional movement of the object, a one dimensional movement of the object or an average gray level variation of the image data) is larger than a threshold value. Therefore, this method is able to avoid error identification of the object movement caused by a tiny difference between two successive image data, and thus is particularly applicable to the detection of the slow moving object.

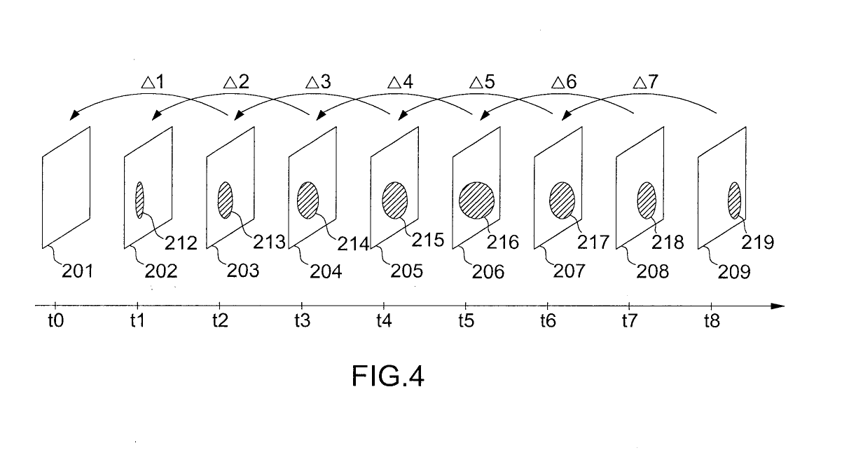

FIG. 4 shows a schematic diagram of the method for detecting object movement according to the third embodiment of the present invention, and this embodiment is preferably suitable for detecting a slow moving object. The difference between the third embodiment and the first embodiment is that, as the object to be detected is a slow moving object, the reference image data is updated at least more than two image data to avoid error identification of the object movement. For example FIG. 4 shows that the reference image data is updated every two image data. In addition, the update frequency of the reference image data may be determined according to the detected movement of the object (i.e.

the object movement data). For example, if the detected object movement is smaller, the reference image data may be updated after more image data. It is appreciated that, herein the processing unit 12 preferably further includes a register configured to store several image data previous to a current image data latest acquired by the image sensor 11, and the number of the image data needs to be stored may be determined according to the actual requirement. The method of the present embodiment is similar to that of the first embodiment (FIG. 1). That is, the image sensor 11 successively acquires images; the processing unit 12 updates a latest acquired image data as a current image data and updates the Nth image data acquired earlier than the current image data as a reference image data, and calculates an object movement data according to a difference between the current image data and the reference image data, wherein N may be 1 or 2 or determined according to the object movement data.

It is known from the above illustrations, the method for detecting object movement according to the present invention is a method mainly for detecting the object moving by performing a step of dynamically updating a reference image data. By dynamically updating the reference image data, the impact of the ambient light change can be reduced so as to avoid the detection error of object movement caused by using fixed reference image data under varying ambient light. In addition, it is able to avoid the frequent updating of the reference image data by setting a threshold value, thereby suitable for the detection of the slow moving object.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A method for detecting object movement, comprising the steps of:
successively acquiring image data with an image sensor;
updating the latest acquired image data as a current image data;
updating the Nth image data acquired earlier than the current image data as a reference image data; and
calculating an object movement data according to a difference between the current image data and the reference image data.

2. The method as claimed in claim 1, wherein N is equal to 1 or 2.

3. The method as claimed in claim 1, wherein N is determined according to the object movement data.

4. The method as claimed in claim 1, wherein the image data are images of at least one object illuminating or reflecting light acquired by the image sensor.

5. A method for detecting object movement, comprising the steps of:
acquiring a first image data as a reference image data;
acquiring a second image data as a current image data;
calculating a difference between the current image data and the reference image data as an object movement data; and
determining whether to update the reference image data according to the difference and a threshold value.

6. The method as claimed in claim 5, wherein the threshold value is a two dimensional movement, a one dimensional movement or an average gray level variation of the image data.

7. The method as claimed in claim 5, further comprising the steps of:
reserving the reference image data when the difference is smaller than the threshold value; and
updating the second image data as an updated reference image data when the difference is larger than the threshold value.

8. The method as claimed in claim 5, wherein the image data are images of at least one object illuminating or reflecting light acquired by the image sensor.

9. The method as claimed in claim 7, further comprising the steps of:
acquiring a third image data and updating the third image data as an updated current image data;
calculating an updated object movement data according to a difference between the updated current image data and the reference image data when the difference is smaller than the threshold value; and
calculating an updated object movement data according to a difference between the updated current image data and the updated reference image data when the difference is larger than the threshold value.

10. The method as claimed in claim 9, wherein the image data are images of at least one object illuminating or reflecting light acquired by the image sensor.

11. A detection system, comprising:
an image sensor configured to generate image data; and
a processing unit configured to receive the image data, to dynamically update a reference image data, and to calculate an objet movement data according to a difference between the reference image data and a current image data, which is a latest image data generated by the image sensor.

12. The detection system as claimed in claim 11, wherein the reference image data is the Nth image data generated earlier than the current image data.

13. The detection system as claimed in claim 12, wherein N is equal to 1 or 2.

14. The detection system as claimed in claim 11, wherein the processing unit further compares the object movement data with a threshold value to determine whether to update the reference image data.

15. A detection system as claimed in claim 14, wherein the threshold value is a two dimensional movement, a one dimensional movement or an average gray level variation of the image data.
